(19) United States
(12) Patent Application Publication
(10) Pub. No.: US 2009/0327308 A1
(43) Pub. Date: Dec. 31, 2009

(54) SYSTEMS AND METHODS FOR PROVIDING A CONSUMPTION NETWORK

(75) Inventors: Samuel J. Carter, Cambridge, MA (US); Kwan H. Lee, Cambridge, MA (US); Dawei Shen, Cambridge, MA (US); Hans Shumacher, Charlotte, NC (US); Ray Garcia, New York, NY (US); Erik S. Ross, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/244,058

(22) Filed: Oct. 2, 2008

Related U.S. Application Data
(60) Provisional application No. 61/076,667, filed on Jun. 29, 2008.

(51) Int. Cl. G06F 17/30

(52) U.S. Cl. 707/10; 707/E17.032

(57) ABSTRACT

Systems and methods for providing a consumption network are provided. A method according to the invention may include receiving purchase information on a mobile device and recording the purchasing information. The information may be transmitted to a central database. At the central database, the information may be recorded and transmitted from the central database to a pre-determined group of users. Alternatively, the information may be transmitted to a group of users directly from the mobile phone associated with the purchasing.

### CROSS REFERENCE TO RELATED APPLICATION

This application claims priority from U.S. Provisional Patent Application No. 61/076,667, filed on Jun. 29, 2008, entitled, “Systems and Methods for Providing a Consumption Network.”

### FIELD OF TECHNOLOGY

Aspects of the disclosure relate to a social network.

### BACKGROUND

Communities of consumers may share similar interests. The relationships between the consumers may affect the consumption behavior in the transactions these make. It would be desirable to provide systems and methods with which a consumption network can be implemented such that consumers that share similar interests can take advantage of the consumption behavior of other consumers sharing similar interests. Specifically, it would be desirable if consumers could leverage on their friend's purchase information and other consumers' purchases so that they may make smarter purchase decisions.

### SUMMARY OF THE INVENTION

It is an object of this invention to provide systems and methods for providing a consumption network. In such systems and methods, consumers can be networked, preferably in real time, with substantially ubiquitous wireless mobile devices. Each of the wireless mobile devices typically includes a high bandwidth network connection. In view of the use of wireless mobile devices by a system according to the invention, the system may be considered, at least in part, a mobile network.

Such a connected consumption environment according to the invention allows consumers to be able to sense the general market, or a market for a specific item, with the help of other consumers. Knowledge of the markets can help consumers make more informed financial decisions.

One embodiment of the invention can be a mobile device-based system that allows one to log in either manually or automatically and share one's transactions while allowing others to access this aggregated data when interested in making specific financial decisions—e.g., buying a product or researching a service. The system may also provide a platform that allows consumers to capture and share itemized purchase decisions that have, conventionally, only resided on a specific merchant's database.

Networks according to the invention may also be limited to a geographical area. One method of limiting the network to a geographical area may include analyzing the structure of the network. One embodiment of the analyzing may utilize the location based services on the mobile and geographical information systems of a mobile phone. Another method of limiting the network may include limiting the network based on related consumption patterns.

The size of a targeted recommendation network can be selectable. In one embodiment of the invention, the selection of the size of the target recommendation network can be varied at least by varying the size of a friend network with different criteria for friendship. Alternatively, the varying of the size of the friend network may be implemented independent of the specific varying of the geographical reach of the network.

One embodiment of a method according to the invention may include using a mobile device to purchase an item or a service and then transmitting the purchase information to a database of purchasing information regarding the purchase of the item or service. The method may further include recording the purchasing information at the central database and transmitting the purchasing information from the central database to a pre-determined group of users.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented.

FIG. 2 shows an exemplary system architecture of a system according to the invention;

FIGS. 3A-3B show graphical user interfaces (GUIs) according to the invention;

FIG. 4A-4B show charts according to the invention;

FIG. 5 shows charts comparing distribution of spending in the according to the invention; and

FIG. 6 shows a distribution of individual transactions according to the invention.

### DETAILED DESCRIPTION OF THE INVENTION

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

With respect to the present invention, a database may be provided that can store the information and make it accessible to software that analyzes and mines the stored data. Such software may further allow phones and web applications to access the results of the analysis and the mining.

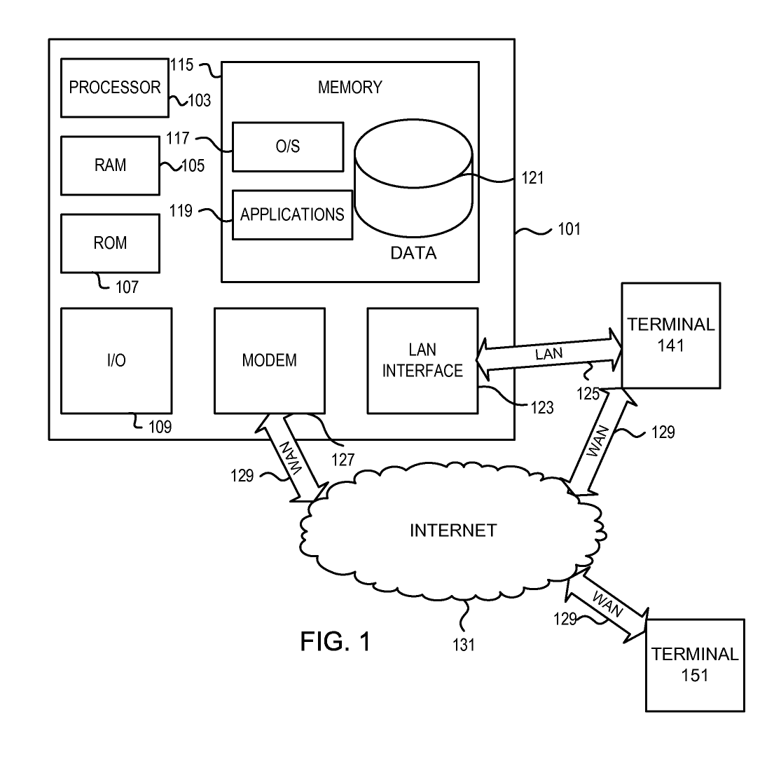

FIG. 1 illustrates a block diagram of a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for purchasing information, purchaser information, general purchasing data and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, Personal Digital Assistants (PDAs), network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

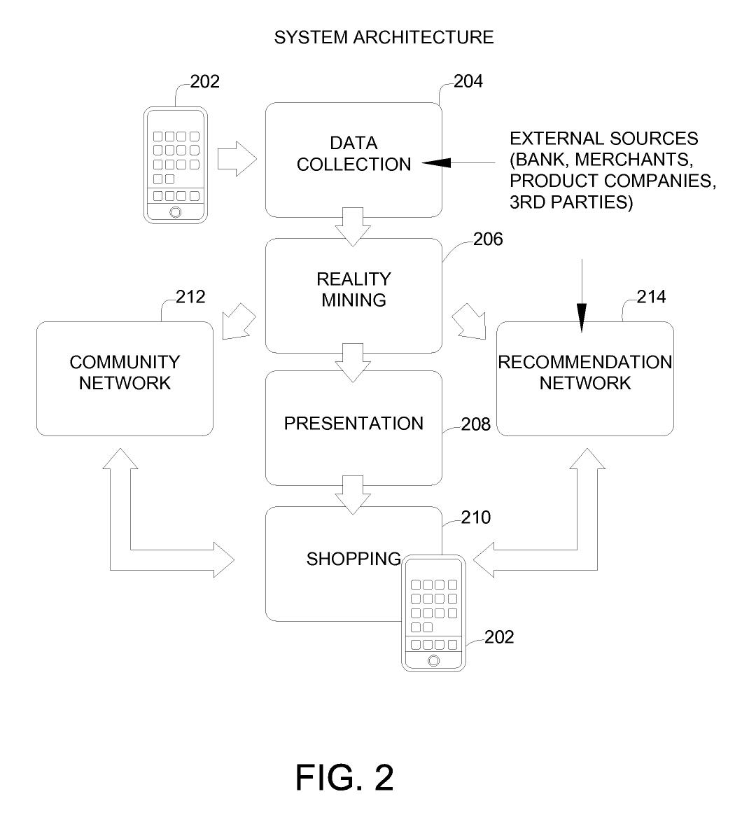

FIGS. 2-6 show illustrative embodiments of systems and methods according to the invention as well as certain research directed to portions of the invention.

Substantially ubiquitous availability of mobile devices that sense the user's context and interest can be used, in methods and systems according to the invention, to provide a platform for network consumers in real time. Such networking can allow users to help each other fulfill their short term and long term goals. Systems and methods according to the invention preferably provide a Connected Consumption Network (CCN) to establish communities of consumers with complementary interests. CCN may help consumers guide their financial behavior with the help of feedback from friends and experts in the social network. Individuals may benefit from being aware of the consumption behavior and the transactions of members of their respective social networks.

A mobile device according to the invention may be able to detect what a user purchases and/or otherwise consumes. Such information deepens understanding of the user's interests as well as the time-variant quality of such interests. These interests can then be mapped, according to the invention, across the social network in order to allow users to leverage the collective knowledge of other users having complementary interests. Mapping the interest network, identifying the influencers and the influenced and tracking the financial transactions of the users (such transactions occurring either at least partially in response to system-based recommendations or independent of such recommendations) may allow systems and methods according to the invention to quantify the economic activity surrounding a social network.

The invention preferably provides a platform that can connect consumers with other consumers of similar interests. Statistical and machine learning approaches can preferably be used to infer a user's friendship network and respective physical context.

Alternatively, or in conjunction therewith, user wish lists and user purchase logs can be used to establish interest networks through CCN. Users may also elect (e.g., on an opt-in or opt-out basis) to share the lists and logs with selected friends and/or the general public via the mobile device. Combined with the user financial information and characteristics and parameters of the social network, the CCN may form a natural idea market for making informed financial decisions.

A system according to the invention may be designed to capture itemized transaction details from participants through manual input and relevant photographic information (such as photographs of brick and mortar stores) taken with a camera in the mobile device.

Alternatively itemized transaction details may be automatically uploaded into a wireless device, either by using the wireless device as the instrument for the purchase or some other suitable communication. While merchants may have POS transaction databases of customer's itemized purchases, these databases are typically specific to those merchants and are not accessible by the user for any purpose. This limitation may be overcome according to the invention at least by making CCN voluntary—i.e., not based off of automatic entry of data in response to wireless-device based purchases. In certain embodiments, the retailers and/or merchants may elect to participate in the CCN and provide line item detail capture to the CCN. Accordingly, the itemized receipt detail can become part of the CCN either by using the wireless device as to purchase items and/or having the merchants and retailers consent to providing their line item receipts to the CCN.

The wireless connectivity of the CCN may allow it to be connected, preferably at all times, to search and receive context sensitive information. By utilizing geographical context from the mobile device at the time of logging and receiving recommendations, the CCN can incorporate relevant data relating to the present physical context of the user.

The information that is pulled from users on the network and pushed to users on the network may, in certain embodiments, be guided by the wish list, purchase logs and/or previous financial transaction behavior. By logging, displaying and sharing of itemized transactions, the system may allow the network to microscopically track the “word of mouth” marketing.

High frequency shoppers use the web heavily (i.e. Angie's List, Consumer Report or CNET Reviews) to inform them about the price, features and reviews of products. Very often these consumers expand this knowledge by asking their friends for references and information. Such information seeking can be improved by socially informing each other.

The system according to the invention may allow identification of experts with a balanced point of view by tracking a user's utilization of different merchants and the accounting of actual purchase activity (such actual purchase activity can be used to inform others of the true experience with the product and/or service).

The system according to the invention can be designed as a user contributory system for purchases so that people can collectively collaborate to understand the market and form a community around purchases, items and/or services. System architecture may be composed of a mobile device front-end, internet back-end, and a reality-mining module. Such a system may help to understand the users by acting as a data repository for storing transactions, an administrator for social network management and a plugin to external services and data sources.

FIG. 2 shows an exemplary system architecture according to the invention. The architecture may include wireless devices 202. The devices preferably act as a front end for data collection. The data collection may be input manually, received from using the wireless device to conduct transactions and/or received from external sources such as banks, merchants, product companies and/or third parties.

The architecture may also include a reality-mining module that receives the data from devices 202 or from other sources and consolidates and/or otherwise transforms the data for use in the community network 212—i.e., for availability to friends, for use in a presentation 208, and/or for use in a recommendation network 214—i.e., for distribution to consumers where a friend has visited but the user has not. Furthermore, a reality-mining engine according to the invention may utilize the collected information over time to infer user's interests.

Each of the community network 212, presentation 208, and recommendation network 214 may be used during shopping 202. Such use may be implemented on wireless device 202.

As mentioned above, certain limitations exist with respect to the current state of transaction information. In conventional systems, only merchants have itemized list of purchases of customer's POS data. Merchants are typically protective of this data and cross-referencing may require close business partnerships. More importantly, customers do not have any systematic access to this data to evaluate their purchases or monitor their financial behavior without manually tracking them. Beyond protecting privacy, the information gives the merchants a competitive advantage, so there is no willingness to share this information. Thus, any access to the data through a POS system would require a close relationship with the merchant.

Similarly, banks are able to capture all types of transactions except cash transactions. However, the details of the transactions typically only capture merchant level information—i.e., information that identifies only the merchant and the amount of the transaction—and the itemized list of products and services is not available. While other applications exist that capture digital receipts, these applications are not known to be available for large scale implementation.

To solve the above-stated problems, a system according to the invention may accept logging of transactions manually. Near Field Communication (“NFC”), a short-range high frequency wireless communication technology which enables the exchange of data between devices over about a 10 centimeter distance and which can be used for mobile phone payment systems—may also be used to implement systems and methods according to the invention. Such NFC may be used to load information on to a consumer's device in order to reduce the burden (of data entry) on the consumer. Such digital receipt using NFC can enable an automated and certified log of purchases to avoid forged data or otherwise unsuitable data. Alternatively, voice recognition software may be used to allow the user to easily enter transaction data.

When a user logs a transaction, the item name, tags, price, and merchant name may be input. Additional annotation may also be used. A user can also attach a picture by using a camera that may be present in the wireless device. In certain embodiments of the invention, the geographical coordinates of the wireless device at POS and time of purchase may be logged automatically.

When the user is interested in purchasing an item, the user can search for it on his wireless device. This user-initiated search may explore the social network to find other users who have made similar purchases. Upon detection of such users, the wireless device may present the findings to the user.

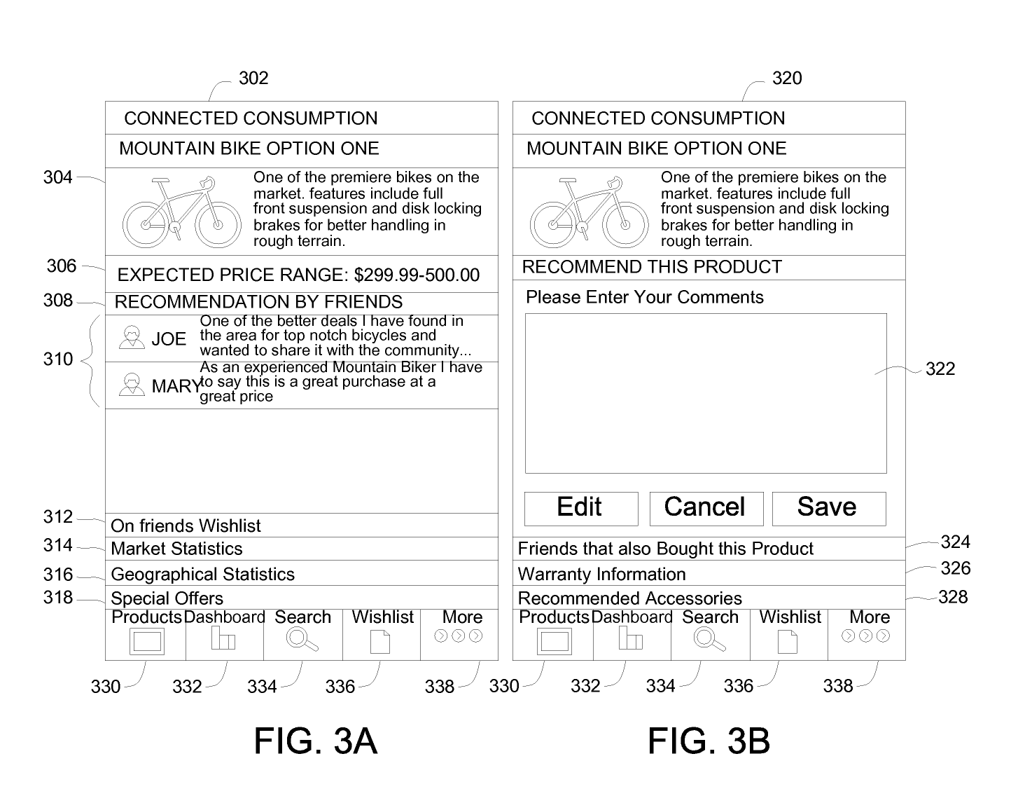

FIG. 3A shows a GUI 302 including a selected product 304. Included as well is an expected price range 306 as well as a recommendations section 308 including individual recommendations 310. Also included are a tab for items “on friends wishlist” 312, a tab for market statistics 314, a tab for geographical statistics 316 and a special offers tab 318. Other tabs across the bottom may include products 330, dashboard 332, search 334, wishlist 336, and more 338.

FIG. 3B shows a display that may include an interactive dialogue box 320 that may be displayed on the wireless device at point of sale (“POS”). Thus, at POS, one can add comments in the comment field 322, as well as access information regarding which friends also bought this product 324 (which may include information concerning any discounts or rewards that friends may have received). Tab 326 may include warranty information about the product and recommended accessories 328.

Individuals who have purchased a certain product often have performed background research. Such background research may be leveraged, using systems and methods according to the invention, to inform others about the product and/or the conditions of purchase. For example, when users see that friends have purchased similar items, users can message friends or directly call them. The prior experience of friends and the social network can be utilized to make more informed purchase decisions. Alternatively, the background research can be stored in a central database so a buyer can search the database to obtain any previously stored information.

A web service—e.g., a software system designed to support interoperable machine-to-machine interaction over a network—according to the invention may provide capabilities for data collection, social networking and reality mining. Wireless devices such as mobile phones may use Representational State transfer (“REST”) APIs—i.e., an application programming interface designed for distributed hypermedia systems such as the World Wide Web—to store wish lists and purchase lists.

The user-associated objects contain wish lists and items purchased. In one embodiment of the invention, most recently purchased items are given greater weight to better model user's transient interests.

In some embodiments of the invention that use GUIs 302 and 304, users are connected with others through a friendship network. Purchased items can be shared among friends or the public. In certain embodiments of the invention, a “common sense” database may be utilized to map out user's interests beyond what they specify through their purchased items so that public information can be intelligently matched. For example, each user interest could be mapped with a weight to be prioritized for constructing social network and filtering recommendations.

Traditional recommendations may be personalized to the level of an individual's interests. Such interests may be specified through surveys and subscriptions during purchase of products or services. However, individual's interests normally evolve over time, location and context. For example, when a person has bought an LCD TV, one will typically not make another big investment in electronics, but, rather, focus more on the content. Nevertheless, useless catalogs are sent by the merchants with a wide variety of offerings that are, at least temporarily, irrelevant to the user. The merchants typically have no situational awareness of the customer to provide the user with what might be useful nor do they have information about the user's financial goals, desires for purchases, or timing of their purchases to help people's future spending. Instead the merchants just provide a constant stream of advertising material with the hope that some of the material will appear before the buyer at an appropriate time.

In systems and methods according to the invention, purchase behaviors and financial information may be utilized to filter out de facto spam from appropriate recommendations. A central database in such a system may be configured to filter the recommendations based on the frequency of purchase, average size of purchase, average spending in a month and the usual categories of spending. For example, if one purchases childcare products only once a month, recommendations can be set to be provided to the user once a month. Recommendations can be further tuned to be sent at least three weeks, or some other appropriate time, following the last purchase of childcare products. If one has an average childcare expenditure of $1000 a month, any purchase recommendations that exceed this budget may be considered spam and may be disregarded by the system.

In certain embodiments of the invention, the level of aggressiveness by which recommendations are treated may be selectable. For example, a user may elect to disregard any recommendations that either exceed a budget or are not aligned with the user's interests. Alternatively, the level of aggressiveness with respect to treatment of recommendations may be system-set.

In certain embodiments of the invention, recommendations (or other communications to friends) may include a buy-it-now feature. For example, one can send a recommendation to a friend that includes a link to a web-page whereby the friend can, if so desired, click on the link and purchase the item immediately from the web-based merchant specified in the link. As such, short-lived offers such as, for examples, sales on airline tickets, can easily and efficiently be communicated among a selected group of consumers. Further, the ability to take advantage of the short-lived offers is improved as well.

Various services can be implemented in a CCN according to the invention. Such services can be beneficial for the community of consumers. For example, the users can receive different levels of aggregate data regarding consumption of different products in different geographical areas. Alternatively, users can receive aggregate data regarding consumption under demographic conditions. Such different levels of aggregate data may generate real time consumer reports and can be used to formulate a relatively broad consumption index.

In a business setting, CCN may provide data that can be utilized for merchants and product companies to access and target user wishlists and to further provide a contextual marketing channel.

A CCN according to the invention may also provide opportunities for a reverse auction so that consumers may save time in their product search. Such a reverse auction may be implemented such that the user enters a price and then the CCN distributes the price, or otherwise identifies the price, to merchants and determines whether merchants can meet the user's offered price.

Financial service providers may also be incentivized to participate in this system. Their participation may extend to handling transactions recorded and/or performed via the CCN and providing contextual financial offers in a timely manner. The financial service providers may provide offers using the CCN at critical times such as when a user expresses interest in purchasing an item, when the user is at the point of sale, and/or when the user engages in financial transactions with other users. At such critical times, the financial service provider can be an authority for the user legitimacy. Value added service to merchants can be provided for premium fees or through separate payment network.

Often people purchase products and services without much awareness of their own spending habits or consideration of the future impacts of the purchase. Current budgeting tools are limited in giving real time feedback when one is considering making a purchase. Research in retail stores indicate that 20% to 60% of purchases occur due to impulsive purchases. A CCN according to the invention may allow spending to be tracked, categorized and then sorted so that people can view, preferably on the mobile device, their consumption summary in real time. With the help of the network according to the invention, one can also receive information regarding how one compares in different spending categories (i.e. my coffee spending, travel spending) with others in similar financial contexts.

The assumption of CCN is that participants contribute, either manually or automatically, and share purchasing records at an itemized level. For the following studies, anonymized data of three months of credit card and debit card transactions have been mined. Though detailed information about purchased products or services is not available, the sample data used for the research does enhance the value to the network of each individual's transaction history.

Two hundred credit card users between ages 20 and 50 were randomly selected from a specific metropolitan statistical area. Though item level information was not obtained, merchant names and shopping categories were available for each transaction. Twenty categories of credit/debit card transactions were studied. These categories include ‘Food Stores’, ‘Restaurants/Bars’, ‘Clothing Stores’, ‘Electronic Alliances’, etc. These 20 categories represent common shopping behaviors. Categories like ‘Cash advance’, ‘Payment’, ‘Refund’ were discarded in the following analysis.

The following analysis assumes that each individual's purchasing behavior or ‘consumption pattern’ can be determined and mined from the merchants he or she visited in the past. As a simpler model, each customer's consumption pattern can be approximated by a length-20 vector where each element represents the amount of money he spends in that category. The relative distribution and absolute amount of spending in different categories can well reveal a customer's interests, habits, and living styles. The following analysis illustrates: 1) the consumption report obtainable from the aggregated information in the large scale network to which he or she is connected and 2) the amount of relevant recommendation information and other shared information consumers can receive from their friends network.

First, a friendship network was generated by randomly clustering the 200 customers into different groups. Each group included between 2 and 9 members. Every pair of members within the same group were connected as friends. Then, weak links were drawn between two customers in different groups. The number of weak links was uniformly distributed between 0 and 100. ‘Mutual Information’ is defined as the number of common merchants that a customer and his/her friends have visited, implying that they have common interests and knowledge about these merchants. ‘Recommendations’ can be defined for the purpose of this application as the number of merchants that at least one friend has visited, but that the user has not.

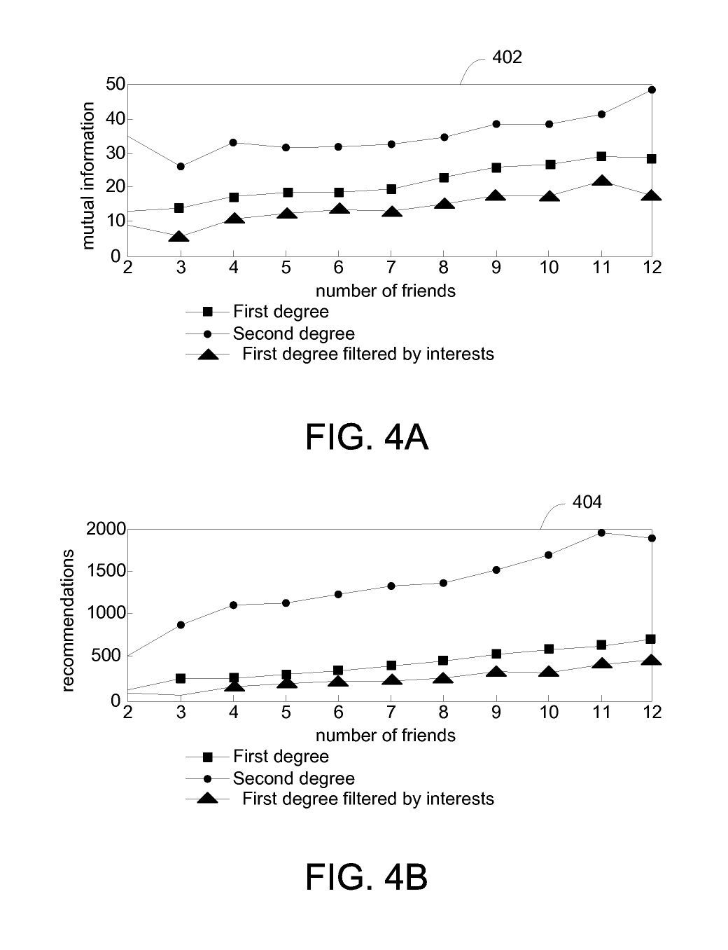

FIGS. 4A and 4B show charts according to the invention which display mutual information (MI) and recommendations (RC) that customers theoretically would have received from their respective social networks. The charts include number of friends as the x-axis and mutual information as the y-axis. The first degree line corresponds to friends of the user. It can be seen from these results that there is a large potential to explore the information hidden inside the social network.

As can be seen from the results, mutual information and recommendations grow substantially linearly with the number of friends each individual has. Each customer can potentially receive approximately forty-five recommendations over a period of three months from each friend.

If the second degree social network opinions—i.e. friends' friends—are considered, the amount of information gets significantly amplified, as well as the privacy and spam concerns. It can potentially annoy individuals when hundreds of recommendations are received each month. Accordingly, a user can filter out information according to his or her own interests and preferences. In FIG. 4A-4B, the MI and RC are filtered by the top 5 spending categories, as shown by the curves at the bottom of FIGS. 4A and 4B. The filtering effectively reduces the amount of information received, but potentially increases the quality or value of the information.

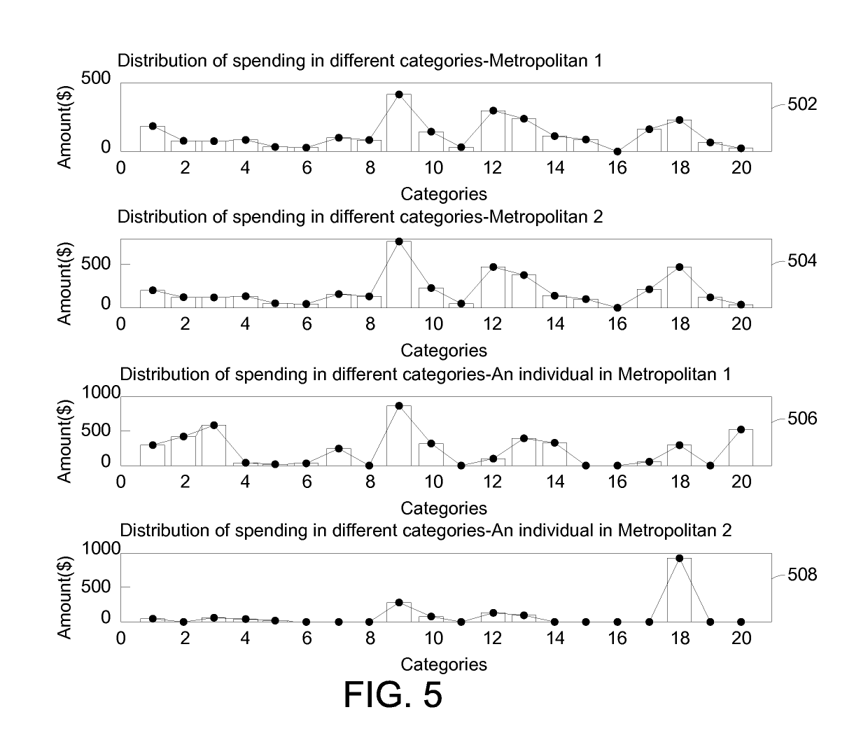

FIG. 5 displays exemplary user interfaces 502-508. A customer can utilize at least two of interfaces 502-508 to compare his own spending in each category and the average amount other consumers spend in the same geographical location and/or age group or other suitable filtering parameter. The two subgraphs at the top 502 and 504 represent the shopping patterns for two major metropolitan areas in the US. The two subgraphs at the bottom 506 and 508 represent two customers living in the second metropolitan area. Such an interface allows a customer to receive feedback on his/her relative consumption level and reflect his or her budgeting and financial planning. Alternatively, such an interface allows a customer to receive feedback on the relative consumption level of his geographical location as compared to another geographic location.

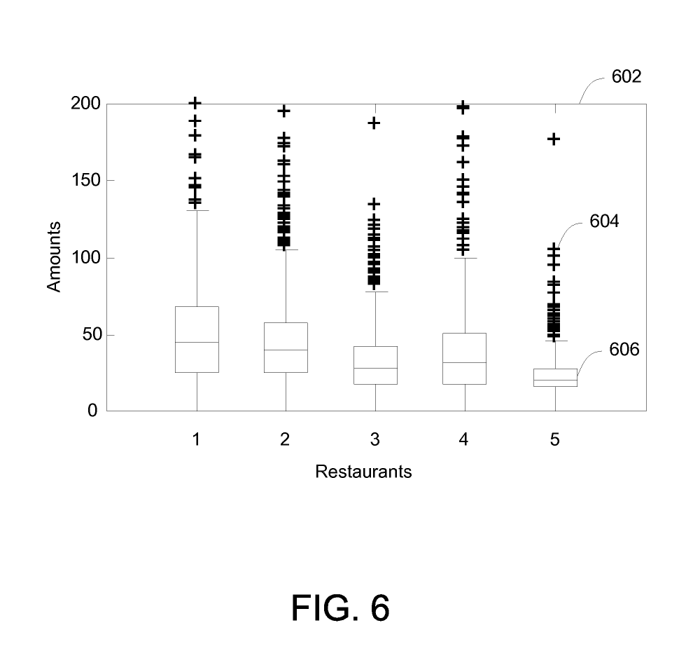

FIG. 6 shows an exemplary user scenario 602 when a customer receives multiple recommendations on restaurants from his/her friends. Specifically, scenario 602 illustrates the distribution of individual transactions in five different restaurants. Plus signs (“+”) 604 represent the transaction amount for individual transactions. Box 606 represents a schematic diagram showing the mean transaction amount for each restaurant relative to the range of transactions.

In this case, scenario 602 was generated from Mobile Service Architecture-2 (“MSA-2”). MSA-2 is a specification that defines a standard set of application functionality for mobile devices. Scenario 602 included over 500 transactions per restaurant. The x-axis shows the five different restaurants and the y-axis shows the amounts spent on the respective transactions.

Depending on the occasion, a user can preferably select between these options based on the expected spending. Similarly in CCN, customers can share their restaurant experiences and allow users to make a choice based on his/her own preferences and financial situation.

The previous results show that systems and methods according to the invention are well suited to enhance aspects of mobile commerce.

Mobile shopping services in Japan generated $1.84 billion in 2004, which represented about 8% of all on-line sales of physical products in Japan that year. 15% of the on-line sales were in fashion-related products. Push mail and discount coupons integrated with merchants and other broadcast media (radio, TV) were the driving business models. Expanding on such potential, systems and methods according to the invention may preferably contribute to building a context-aware, socially-aware, finance-aware mobile shopping experience.

With mobile communication becoming pervasive, different types of digital payment and digital receipt systems are being implemented in mobile computing environments. The main focus of the digital payment and digital receipt systems is on making current payment system more efficient by using mobile devices.

Systems and methods according to the invention preferably present a holistic framework to the world of digital payment and digital receipt systems. CCN preferably improves mobile transactions so that they can become a relational experience by embedding social network and personalization around the mobile shopping experience. When friends are involved in transactions, research has shown that the transaction becomes relational where future consequences are taken into account during transactions. CCN presents opportunities for making shopping experience more relational.

The same mobile phones that detect user's financial transactions in digital payment and digital receipt systems are able to detect and, preferably, forecast user's long term and transient interests. The long term interests can be aggregated and communicated to the user at periodic intervals instead of alerting the user continuously. The transient interests can be used opportunistically when users are geographically in closer proximity to a store and in a timely manner when they have higher probability of purchase during weekend or evening hours. It would be at best inefficient to alert the user with furniture store sales when the user is commuting to their work.

Sharing financial transactions may be a very sensitive issue. One aspect of CCN that prevents unwanted disclosure of financial information is a mechanism by which users can control which transaction items to share (opt-in). Those that are closed may only used for generating aggregate information.

There is uncertainty about whether the consumers are willing to accept mobile advertisements on their phones at least because of spam and unsolicited communications. The small screens also limit the effectiveness of the advertisement. However, market research shows that consumers are willing to accept advertising if the advertising directly benefits them through coupons that can be used in brick and mortar stores. Research of SMS campaigns in Europe have shown that people like the advertisements they receive from trusted sources. Studies also show that 23% of people are willing to forward the advertisements to their friends. In other research surveys, 65% wanted personalized advertisements and 45% wanted location specific advertisements. All of these studies indicate that a design around social and physical context may be important for the adoption of recommendations through CCN.

The simulations described herein show how much more “information aware” consumers can be when they are socially networked through a CCN-like system. By building a system of actual transactions and establishing connections to share purchasing experiences among friends and social network, the quality of information and recommendations can be increased. Furthermore, true expert and/or experienced consumers can be identified from the purchases they have made. Thus, less time is wasted on preparing and reviewing random reviews. CCN is an attempt to bring such enhanced social shopping experience to the mobile context while helping consumers to help each other for smarter spending.

Thus, systems and methods for implementing a consumption network have been provided. Persons skilled in the art will appreciate that the present invention can be practiced by other than the described embodiments, which are presented for purposes of illustration rather than of limitation, and that the present invention is limited only by the claims that follow.

What is claimed is:

1. A communications network comprising:
a plurality of mobile phones, each of said mobile phones enabled to receive and record purchasing decisions; and
a central database for receiving information from the plurality of mobile phones corresponding to the purchasing decisions and for distributing at least a portion of the information to a portion of the plurality of mobile phones.

2. The system of claim 1 wherein the central database transmits purchasing decisions to a pre-determined group of users.

3. The system of claim 1 wherein at least one of the mobile phones transmits purchasing decisions to a pre-determined group of users.

4. The system of claim 1 wherein the central database transmits purchasing decisions to a pre-determined group of users upon request by the pre-determined group of users.

5. The system of claim 1 wherein the central database transmits purchasing decisions to a pre-determined group of users upon request by the owner of the mobile device.

6. The system of claim 1 wherein the central database is distributed over a plurality of locations.

7. One or more computer-readable media storing computer-executable instructions which, when executed by a processor on a computer system, perform a method for providing a consumer consumption network, the method comprising:
receiving purchase information on a mobile device;
recording the purchasing information;
transmitting purchasing information to a central database;
recording the purchasing information at the central database; and
transmitting purchasing information from the central database to a pre-determined group of users.

8. The method of claim 7 further comprising configuring at least one of the mobile phones to transmit purchasing decisions directly to a pre-determined group of users.

9. The method of claim 7 wherein the central database transmits purchasing decisions to a pre-determined group of users upon request by the owner of the mobile device.

10. The method of claim 7, wherein the central database transmits purchasing decisions to a pre-determined group of users upon request by the pre-determined group of users.

11. A communications network comprising:
a central database for coordinating communication between a plurality of mobile phones, each of the mobile phones enabled to receive and record purchasing information, the central database configured to receive and store purchasing information from each of the plurality of mobile phones, the central database further configured to transmit selected purchasing decision information from each mobile phone to other mobile phones.

12. The system of claim 11 wherein the central database transmits purchasing decisions to a pre-determined group of users.

13. The system of claim 11 wherein at least one of the mobile phones transmits purchasing decisions directly to a pre-determined group of users.

14. The system of claim 11 wherein the central database transmits purchasing decisions to a pre-determined user upon request by the pre-determined user.

15. The system of claim 11 wherein the central database transmits purchasing decisions to a pre-determined group of users upon request by the owner of the mobile device.

16. One or more computer-readable media storing computer-executable instructions which, when executed by a processor on a computer system, perform a method for providing a consumer consumption network, the method comprising:
using a mobile device to purchase an item or a service;
transmitting to a central database purchasing information regarding the purchase of the item or service;
recording the purchasing information at the central database; and
transmitting the purchasing information from the central database to a pre-determined group of users.

17. The method of claim 16 further comprising configuring at least one of the mobile phones to transmit purchasing decisions directly to a pre-determined group of users.

18. The method of claim 16 wherein the central database transmits purchasing decisions to a pre-determined group of users upon request by the owner of the mobile device.

19. The method of claim 16 wherein the central database transmits purchasing decisions to a pre-determined group of users upon request by the pre-determined group of users.

20. The method of claim 16 further comprising distributing information from the central database to a plurality of databases.
